(19) United States
(12) Patent Application Publication
(10) Pub. No.: US 2008/0079870 A1
(43) Pub. Date: Apr. 3, 2008

(54) SMALL-ANGLED, PREDETERMINED-POSITIONED AND PREDETERMINED-ORIENTATED LIGHT EMITTING DEVICE OF BACKLIGHT MODULE OF LIQUID CRYSTAL DISPLAY

(76) Inventors: Miyashita Kazuhiro, Kaohsiung (TW); Yu-Ping Liu, Kaohsiung (TW); Chao-Fang Chung, Kaohsiung (TW)

Correspondence Address: Miyashita Kazuhiro, 235 Chung - Ho Box 8-24 Taipei, Taiwan, R. O. C., Taipei, 235, TW

(21) Appl. No.: 11/939,557

(22) Filed: Nov. 14, 2007

Related U.S. Application Data
(63) Continuation-in-part of application No. 10/812,574, filed on Mar. 29, 2004, now abandoned.

(51) Int. Cl. G02F 1/13357

(52) U.S. Cl. 349/67

(57) ABSTRACT

A small-angled, predetermined-positioned and predetermined-orientated light emitting device of a backlight module of a liquid crystal display comprises: a plurality of lower prisms; and each lower prism having an emitting face; a light guiding plate (LGP) being integrated with the plurality of lower prisms as an integral unit; a plurality of upper prisms; each upper prism having an entering face and an total reflecting face, an upper prism plate being integrated with a plurality of upper prisms as an integral unit. Emitting light beams nonuniformly distributes from predetermined positions, and each emitted light beam is limited to a small angle range.

The present invention is a continuation in part of U.S. patent Ser. No. 10/812,574, which is assigned to the inventor and applicant of the present invention. Thus the content of U.S. patent Ser. No. 10/812,574 is incorporated into the present invention as a part of the present invention.

### BACKGROUND OF THE INVENTION

1. Field of the Invention

The present invention pertains to a kind of LCD backlight module which emitting light beams nonuniformly from predetermined positions, with each emitted light beam limited to a small angle range.

2. Description of Related Art

The prior arts of backlight module mainly focus on emitting light evenly; As shown in U.S. Pat. No. 6,356,391, the backlight module is formed by prism arrays and aims to have light continuous and entire evenness.

Further, as shown in U.S. Pat. No. 5,917,664, it provides a prism arrays aiming to avoid a sudden change of brightness when across predetermined angle during change of the viewing-angle.

Technological thought of small-angled, predetermined-positioned and predetermined-orientated light emitting device of a backlight module of a liquid crystal display of the present invention is distinct from those prior arts.

As illustrated in Part1 and Part2 of FIG. 8, “light guiding plate having multi-focused reflecting patterns” of the TAIWAN PATENT published No. 463957 has a plurality of multi-focused reflecting patterns on an opposite face of an emitting face of a light guiding plate. Each pattern has a round surface at a center area with a plurality of annular round surfaces being concentric from the round surface. Incident light is reflected, by each pattern on LGP, upwards to form plane-type light source. This prior art is that brightness of plane-type light source is made evenly distributed by multi-directional reflection of multi-focused reflecting mirrors. Technological thought of the present invention is distinct from this prior art.

As illustrated in Part1 and Part2 of FIG. 9, “plane-type light source” of TAIWAN PATENT published No. 538285 utilizes multi-direction refraction of concave lenses 11n or convex lenses 11p to make emitting face approximately equal to lateral incident face have enough brightness.

As illustrated in Part1 and Part2 of FIG. 10, and Part1 and Part2 of FIG. 11, this prior art also has variant distribution concentration of concave mirrors 12p or convex mirrors 12n on the opposite face of an LGP's emitting face and lateral faces except incident face.

By the way of multi-direction of concave and convex mirrors' reflection and higher concentration of reflecting mirrors in periphery of LGP h where brightness is apt to be insufficient, it is possible to achieve evenness of brightness and direction of emission of plane-type light source. The technological thought of the present invention is distinct from this prior art.

As illustrated in FIG. 12, “LCD having localized-light-transmitting backlight” of TAIWAN PATENT published No. 560621 has a plurality of light passages 52 in reflecting layer 51 on the bottom of LCD f, and has a micro-prisms-arrayed optical film g possessing light-focusing portions 61 corresponding to light passages 52, between LCD f and LGP h. The artificial light L5, after being concentrated, transmits through light passages 52 in reflecting layer 51, and into LCD f. The total output comes from combined effects of highly reflected natural light L4 from reflecting layer 51 and artificial light L5 enhanced by micro-prism-arrayed optical film g, with enhanced total light output of LCD.

The stronger function of light-focusing portions 61, the more artificial light L5 transmitting through light passages 52, and the less proportion of area occupied by light passages 52, and therefore the larger proportion of area used to reflect, and then more reflected natural light L4 can be used. According to this design, light output of LCD f can be promoted, and contrast of LCD f to natural light L4 can be increased.

This prior art is characterized in reflecting layer 51 possessing light passages 52 and micro-prisms-arrayed optical film g possessing light-focusing portions 61.

Although it would make emitted artificial light L5 point to predetermined positions according to its claims' declaration, the critical structure of micro-prisms-arrayed optical film g possessing light-focusing portions 61 and corresponding parameters thereof are not disclosed at all.

According to drawings of this prior art, its micro-prisms-arrayed optical film g is independent from LGP. The macrostructure of this prior art is different from that of the present invention which has a plurality of lower prisms engaged together with LGP and an independent upper prism plate possessing a plurality of upper prisms.

Most important of all, the present invention discloses not only its optical process, but the microstructure also, including its characteristics and its corresponding parameters.

### SUMMARY OF THE INVENTION

The aim of the present invention is to solve the problem of conventional backlight module wherein a large amount of energy is wasted in illuminating opaque portion of LCD substrate such as common electrode and black matrix, and to provide a kind of backlight module which emits light beams nonuniformly from predetermined positions, with each beam limited to small angle range and pointing to predetermined opening of LCD substrate.

To achieve above object, the present invention provides a small-angled, predetermined-positioned and predetermined-orientated light emitting device of a backlight module of a liquid crystal display, the LCD backlight module emitting light beams from predetermined positions, limited to small angle ranges, and pointing to predetermined orientations, the light emitting device comprising: a plurality of lower prisms; each lower prism having an emitting face which causes light beams to propagate in predetermined angles range inside an LGP transmitted through an emitting face of a lower prism; a light guiding plate (LGP) being integrated with a plurality of lower prisms as an integral unit; wherein a light beam propagating in predetermined angle range inside the lighting guiding plate will transmit through the emitting faces of lower prism; a plurality of upper prisms; each upper prism having an entering face and an total reflecting face, making light beams transmitting into an entering face be reflected totally from its total reflecting face and transmit through upper prism plate in predetermined orientations; an upper prism plate being integrated with a plurality of upper prisms as an integral unit; when a light beam transmits into an entering face of one of the upper prisms will be reflected totally from the total reflecting face and then transmitting through upper prism plate in predetermined orientations.

Each of the lower prisms and the upper prisms has a quasi-triangle cross section; and a light beam propagating in predetermined angles range inside the LOP is refracted by a corresponding lower prism and transmits through the emitting face of each the lower prisms, and across an air gap. The light beam is incident into, refracted by and transmits into the entering face of a corresponding upper prism; the light beam propagates inside the upper prism and onto the total reflecting face, and then the light beam is totally reflected from the total reflecting face, and further the totally reflected light beam transmits through the upper prism plate, limited to small angle range, pointing to predetermined orientations, being able to be looked as if those were emitted from corresponding predetermined positions of LGP.

### BRIEF DESCRIPTION OF THE DRAWINGS

FIG. 1 illustrates the structure of the present invention.

FIG. 2 illustrates the optical process of the present invention.

FIG. 3 illustrates the parameters of the structure of the present invention.

FIG. 4 illustrates the small angle range of the emitted light beam of the present invention.

FIG. 5 illustrates effect about the light beam width when reaching LCD substrate without any film having similar refractive index of upper prism 3.

FIG. 6 illustrates the effect on a light beam width when reaching LCD substrate with film having similar refractive index of upper prism 3.

FIG. 7 illustrates the parameters involved in embodiments of the present invention.

FIG. 8 illustrates representative drawing of “light guiding plate having multi-focused reflecting patterns” of TAIWAN PATENT published No. 463957.

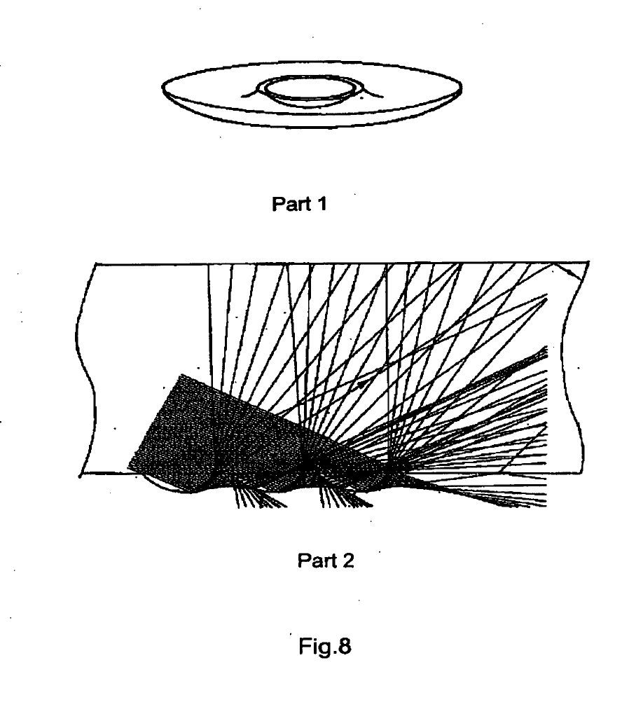

FIG. 9 illustrates the first representative drawing of “plane-type light source” of TAIWAN PATENT published No. 538285.

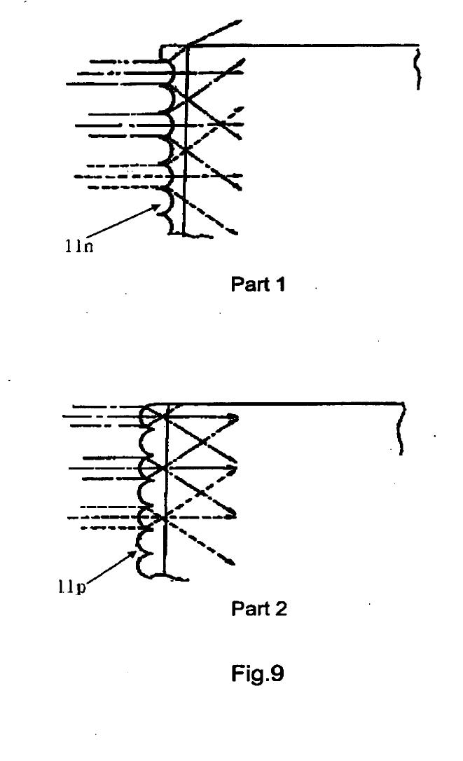

FIG. 10 illustrates the second representative drawing of “plane-type light source” of TAIWAN PATENT published No. 538285.

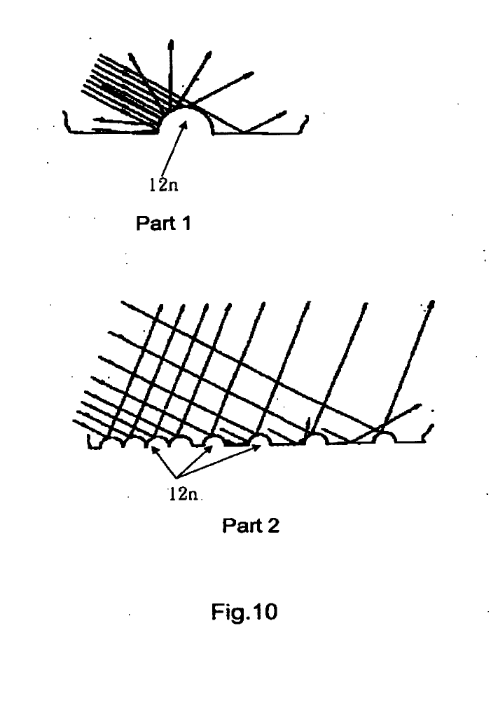

FIG. 11 illustrates the third representative drawing of “plane-type light source” of TAIWAN PATENT published No. 538285.

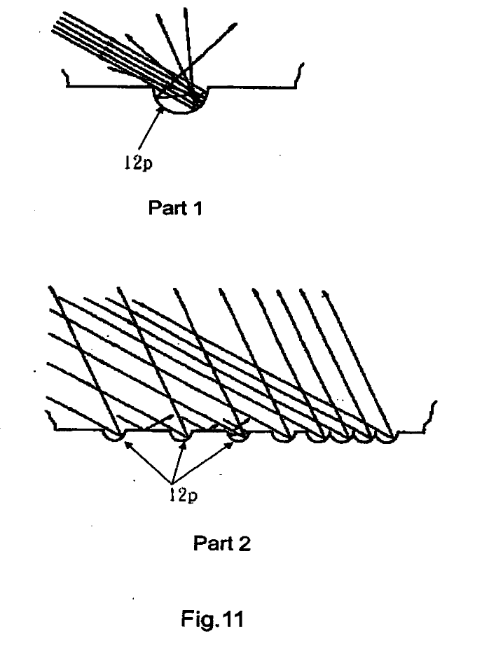

FIG. 12 illustrates representative drawing of “LCD having localized-light-transmitting backlight” of TAIWAN PATENT published No. 560621.

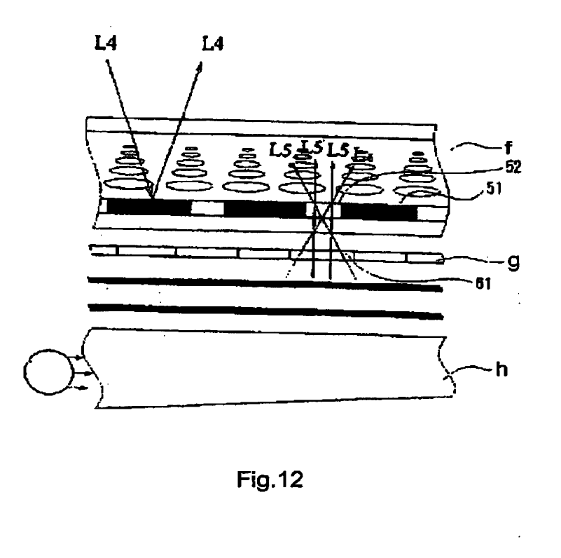

### DETAILED DESCRIPTION OF PREFERRED EMBODIMENT OF THE PRESENT INVENTION

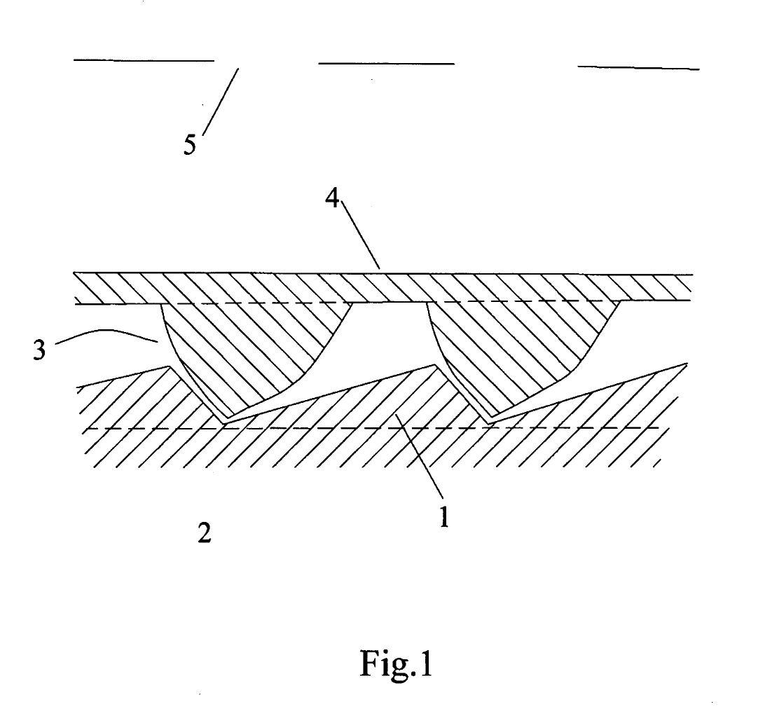

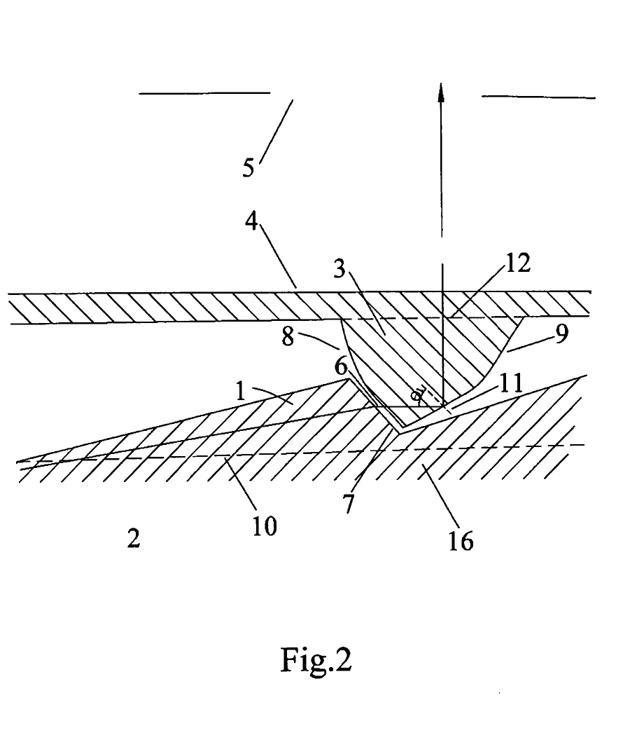

As illustrated in FIG. 1 and FIG. 2, the structure of the present invention includes:

A plurality of lower prism 1 is included.

A light guiding plate 2 (LGP) is integrated with a plurality of lower prisms 1 as an integral unit.

When a light beam propagating in predetermined angles range inside the lighting guiding plate 2 will transmit through the emitting faces 7 of lower prism 1;

A plurality of upper prisms 3 are included.

An upper prism plate 4 is integrated with a plurality of upper prisms 3 as an integral unit.

When a light beam transmits into an entering face 8 of one upper prism 3, the light beam will be reflected totally from a total reflecting face 9 and then transmit through upper prism plate 4 in predetermined orientations;

Each cross section of the lower prism and the upper prism 3 is a quasi-triangle. The following descriptions and illustrations of the present invention will assume prism and upper prism having quasi-triangle cross section as representative examples to describe.

As illustrated in FIG. 2, the optical transmitting process of the present invention is described as follows:

The light beams propagating in predetermined angles range (with respect to LGP2) inside LGP2 are refracted by each lower prism 1 and then transmit through the emitting face 7 of each lower prism 1, and transmits across an air gap 6 between the prisms 2 and 3. Then the light beams are incident into the entering face 8 of a corresponding upper prism 3. Light beam propagates inside upper prism 3 and then into the total reflecting face 9, and then the light beam is totally reflected from the total reflecting face 9. Then the totally reflected light beam transmits through upper prism plate.

The light beam transmitting through the upper prism plate 4 is limited to a small angle range. The orientations of the small angle range may be some predetermined orientations.

In one representative example, the orientation of the small angle range includes one pointing to a predetermined opening 5 of a LCD substrate and approximately vertical to upper prism plate 4.

The light beam transmitting through the upper prism plate 4 can be viewed as if the light beam emits from a predetermined corresponding position on LGP.

In the descriptions of the present invention, it is taken as a representative example that a light beam transmitting through the upper prism plate 4 can be viewed as if those emit approximately equal to a border 16 of two neighboring lower prisms.

The optical process described above has the following characteristics:

(1) Each light beam transmitting through upper prism plate 4 is emitted only from border's approximately equal the corresponding lower prisms;

(2) Each light beam transmitting through upper prism plate 4 is limited to a small angle range, with orientations of the small angle range include one pointing to a predetermined opening 5 of LCD substrate and vertical to upper prism plate 4;

(3) Lines drawn from borders of each two neighboring lower prisms and approximately vertical to upper prism plate 4, will transmit through corresponding openings 5 of LCD substrate;

(4) The angle θ₁, formed by incident ray on total reflecting face 11 and normal of total reflecting face 11 is equal to or greater than the critical angle θ_{c} of upper prism 3's material;

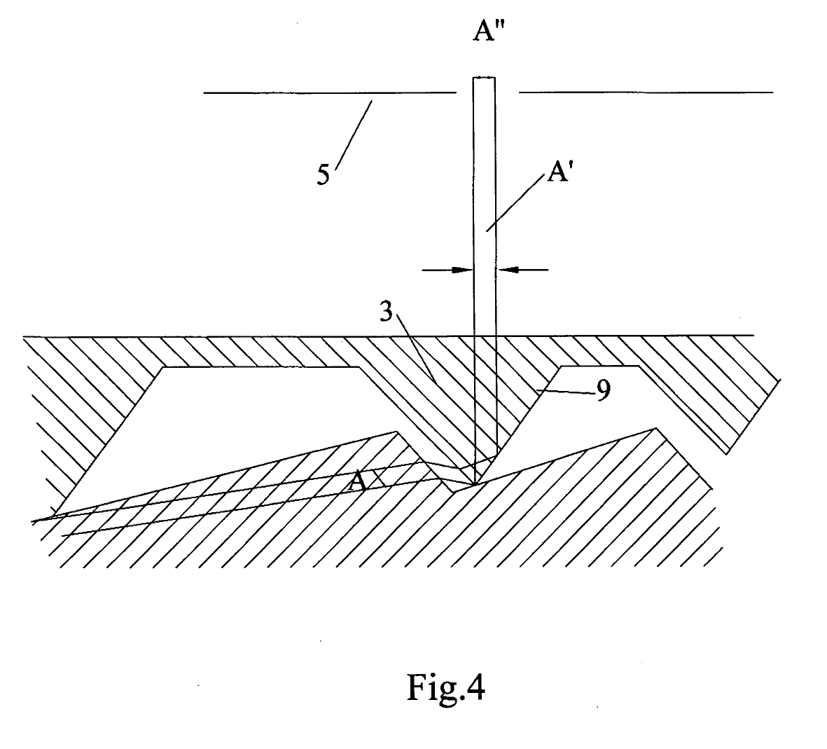

(5) A width A′ of light beam transmitting through upper prism plate 4 is approximately equal to a width A of the light beam before leaving from the lower prism 1, as illustrated in FIG. 4.

To achieve the optical process described above, the lower prisms 1 and upper prisms 3 have to possess the following characteristics and have the following relationships with the LGP2, the upper prism plate 4 and the LCD substrate.

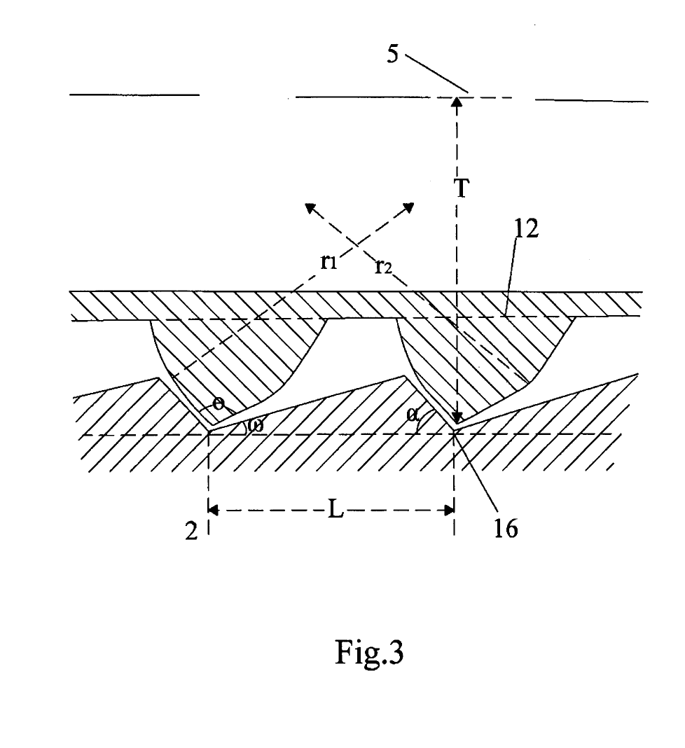

For describing the relationship, we must define the following parameters with reference to FIG. 2 and FIG. 3:

(1) A length L of a bottom side 10 of a quasi-triangle of a lower prism 1 (i.e. a border line between the lower prism 1 and the LGP2) is approximately equal to a distance of a neighboring openings 5 of an LCD substrate;

(2) Lines drawn from the borders 16 of two neighboring lower prisms and approximately vertical to the upper prism plate will transmit through a corresponding openings 5 of the LCD substrate,

(3) A range of an opposite angle ω of the emitting face 7 of the lower prism 1 7 has the following relationship:
0<ω≦0.5θ_{c},

wherein θ_{c} is critical angle of lower prism 1's material;

(4) A range of an angle α formed by the emitting face 7 and a bottom side 10 of lower prism 1 is:
0<α≦90°;

(5) A range of a vertex angle θ of the quasi-triangle of the upper prism 3 approximately equal to the LGP 2 is:

90°−θ_{c}≦θ≦180°−α−ω, wherein θ_{c} is critical angle of the material of the lower prism 1; and α is an angle formed by the emitting face 7 and a bottom side 10 of the lower prism 1, and ω is an opposite angle of the emitting fact of the lower prism 1;

(6) A range of the curvature radius r₁ of the entering face 8 of the upper prism 3 is:
T<r₂≦∞,

wherein T is the shortest distance between the LCD reflecting layer and an intersecting point of the entering face 8 of the upper prism 3 and the total reflecting face 9 of the upper prism 3;

(7) A range of curvature radius r₂ of the total reflecting face of the upper prism 3 is:
T<r₂≦∞,

wherein T is the shortest distance between the LCD reflecting layer and an intersecting point of the entering face 8 of the upper prism 3 and the total reflecting face 9 of the upper prism 3;

(8) A curvature center of the entering face 8 and the total reflecting face 9 of the upper prism 3 are above the border 12 between upper prism 3 and the upper prism plate 4 (i.e. an opposite side 12 of the vertex angle θ of the quasi-triangle of the upper prism 3).

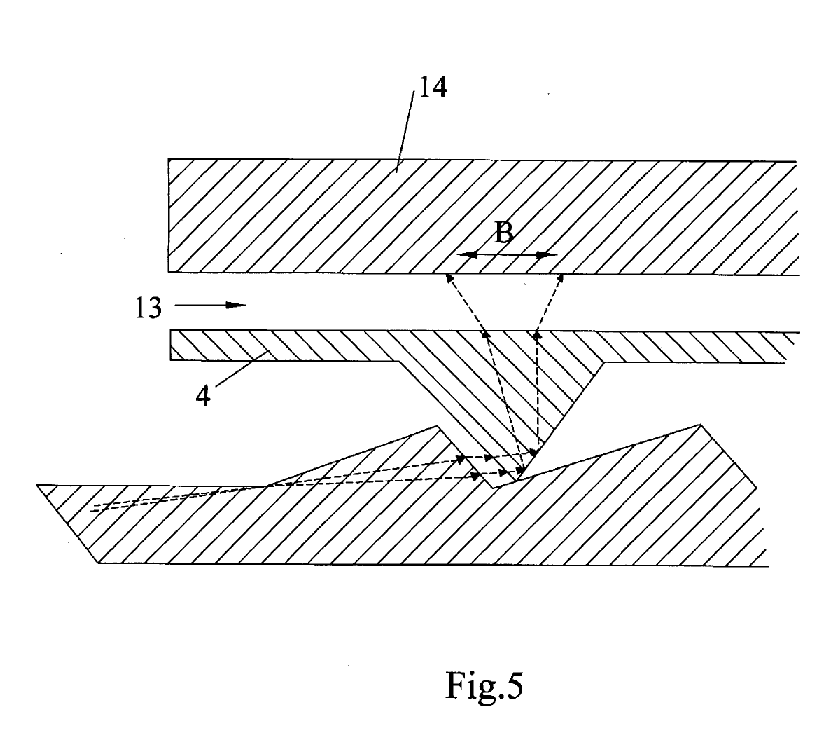

As illustrated in FIG. 5, when an air layer 13 (which can not be neglected) is formed between the LCD 14 and a backlight module. Each light beam is emitted from the upper prism plate 4 into the air layer 13 to have a refractive angle which cause that the light beam width B becomes larger when reaching LCD 14's substrate.

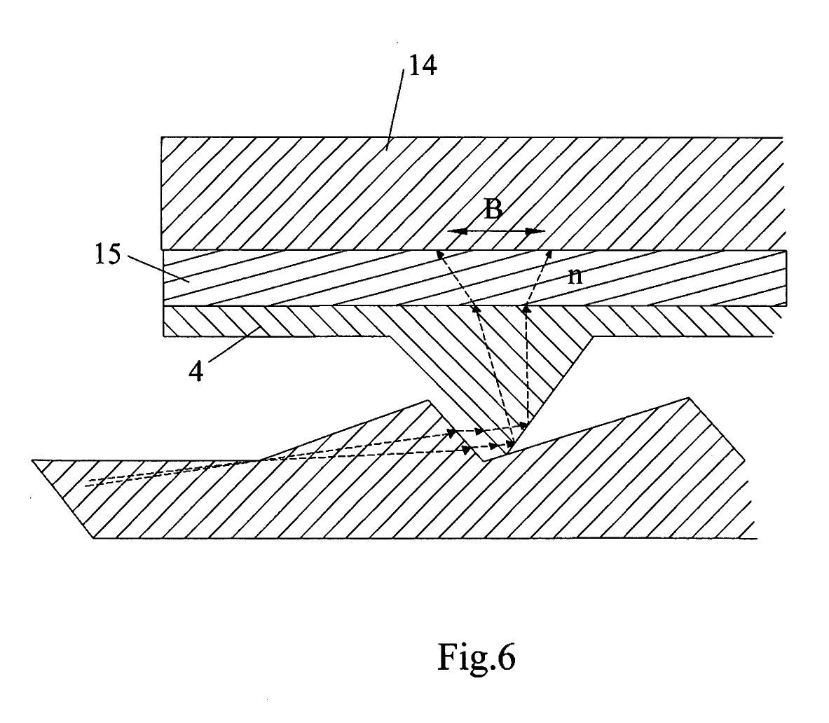

As illustrated in FIG. 6, a film 15 having a refractive index approximately equal to that of the upper prism 3 is adhered between the upper prism plate 4 and the LCD 14. Since the refractive indexes are similar, light beam width B′ is smaller than B, when reaching LCD 14's substrate.

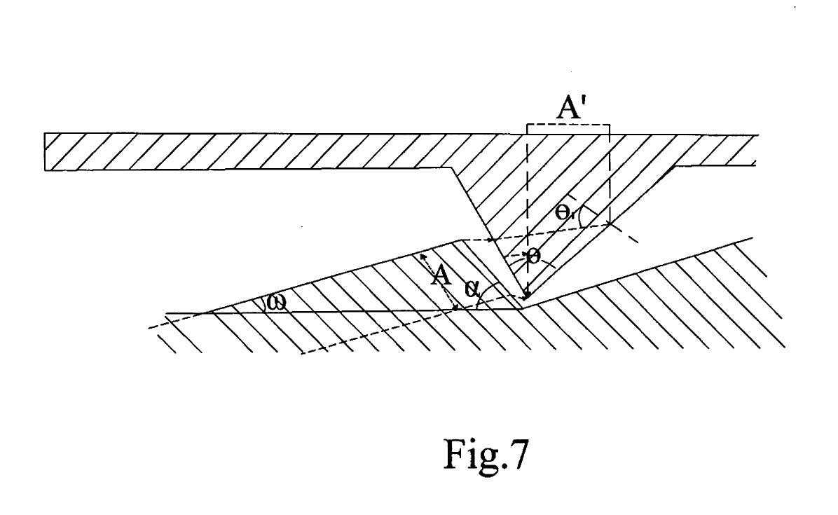

Two embodiments of “a small-angled, predetermined-positioned and predetermined-orientated light emitting device of the backlight module of a liquid crystal display” according to the present invention are described hereinafter with reference to FIG. 7 and Table. 1. Those predetermined numeric values proposed in each embodiment are only some part of the present invention, and the range of the present invention is not limited thereto.

TABLE 1
n = 1.49, θc = 42.2°, the light source being quasi-parallel light beams
paralleling opposite side of α angle, r1 = ∞, r2 = ∞, a thickness of the
upper prism plate 4 being 0.7 mm, n = refractive index of LGP material,
θ₁ being angle formed by incident ray and normal of total reflecting
face, A being width of light beam when it inside lower prism 1, A′
being width of light beam when it leaving upper prism 3, orientation
being angle in which light beam emitted from upper prism plate with
respect to upper prism plate

| embod- | parameter value | | | | | | result |
|---|---|---|---|---|---|---|---|
| iment | ω | α | θ | θ₁ | A | A′ | orientation |
| 1 | 10° | 50° | 80° | 50° | ≈0.035 mm | ≈0.03 mm | ≈90° |
| 2 | 21.1° | 50° | 74.5° | 55.6° | ≈0.074 mm | ≈0.07 mm | ≈90° |

As shown in Table. 1, within the range of parameters proposed by the present invention, i.e.:
0<ω≦0.50θ_{c}, (1)
0<α≦90°, (2)
90°−θ_{c}≦θ≦180°−α−ω, (3)
T<r₁≦∞, (4)
T<r₂≦∞, (5)

Incorporated with relationships of concerned elements and parts, proposed by the present invention, in which both lower prism and upper prism are related to the LGP, the upper prism plate, the openings of LCD substrate, and the reflecting layer of LCD, the aim of the present invention: backlight module emitting light beams, from predetermined positions, limited to small angle range, and pointing to openings of LCD substrate, is accomplished.

The focus of the present invention is that backlight module emits light beams, from predetermined positions, limited to small angle range, and pointing to openings of LCD substrate, and that the light beam optical process has the characteristic, and that lower prism and upper prism within the parameters range have the relationships proposed by the present invention with the LGP, upper prism plate, openings of LCD substrate, and reflective layer of LCD.

Any individual numeric value derived from spirit of the present invention by logical reasoning, mathematic calculation, or computer simulation, and any equivalent variation or modification are to be within claims range of the present invention. The embodiments mentioned above are only a portion of the present invention, the claims range of the present invention are not to be limited to those embodiments.

What is claimed is:

1. A small-angled, predetermined-positioned and predetermined-orientated light emitting device of a backlight module of a liquid crystal display, the LCD backlight module emitting light beams from predetermined positions, limited to small angle range, and pointing to predetermined orientation, the light emitting device comprising:
a plurality of lower prisms; and each lower prism having an emitting face;
a light guiding plate (LGP) being integrated with the plurality of lower prisms as an integral unit; wherein a light beam propagating in predetermined angle range inside the lighting guiding plate will transmit through the emitting faces of one lower prism; wherein the emitting face of the lower prism causes light beams to propagate in predetermined angle ranges inside the LOP and transmits through an emitting face of lower prism;
a plurality of upper prisms; each upper prism having an entering face and an total reflecting face,
an upper prism plate being integrated with a plurality of upper prisms as an integral unit; when a light beam transmits into an entering face of one of the upper prisms will be reflected totally from the total reflecting face and then transmitting through upper prism plate in predetermined orientations; wherein the entering face and an total reflecting face of the upper prism cause light beams to transmit into an entering face thereof are reflected totally from a total reflecting face thereof and transmit through one of the upper prism plates in predetermined orientations;
wherein each of the lower prisms and the upper prisms has a quasi-triangle cross section; and
wherein a light beam propagating in predetermined angles range inside LGP is refracted by a corresponding lower prism and transmits through the emitting face of each lower prism, and across an air gap; the light beam is incident into, refracted by and transmits into the entering face of a corresponding upper prism; the light beam propagates inside the upper prism and onto the total reflecting face, and then the light beam is totally reflected from the total reflecting face, and further the totally reflected light beam transmits through the upper prism plate, limited to small angle range, pointing to predetermined orientations, being able to be looked as if those are emitted from corresponding predetermined positions of LGP.

2. The light emitting device according to claim 1, wherein
a range of an angle α formed by the emitting face and a bottom side of lower prism is:
0<α≦90°;
a range of an angle ω of the lower prism's emitting face opposite to the angle α is:
0<ω≦0.5θ_{c};
where θ_{c} is a critical angle of the material of the lower prisms;
a range of a vertex angle θ of upper prism's quasi-triangle, which is approximately equal to LGP is:
90°−θ_{c}≦θ≦180°−α−ω;
where θ_{c} is critical angle of the material of the lower prism; α is angle formed by emitting face and a bottom side of lower prism, and ω is opposite angle of the emitting face of the lower prism;
a range of a curvature radius of the upper prism's entering face r₁ is:
T<r₁≦∞, and
a range of curvature radius of upper prism's total reflecting face is:
T<r₂≦∞;
where the T is the shortest distance between LCD substrate and intersecting point of entering face of upper prism and total reflecting face of upper prism.

3. The light emitting device according to claim 2, wherein a length of bottom side of the quasi-triangle of the lower prism contacting the LGP is approximately equal to a distance of an openings of an LCD substrate.

4. The light emitting device according to claim 2, wherein the totally reflected light beams transmitting through the upper prism plate are limited to predetermined angle ranges; orientations of the angle range point to openings of an LCD substrate.

5. The light emitting device according to claim 2, wherein the totally reflected light beams transmitting through the upper prism plate are limited to a predetermined angle range; orientations of the angle range including those vertical to the upper prism plate.

6. The light emitting device according to claim 2, wherein lines drawn from borders of the lower prisms and vertical to upper prism plate pass through openings of LCD substrate.

7. The light emitting device according to claim 2, wherein after the light beam transmits through the emitting face of each lower prism and across air gap, the light beam is incident on, refracted by and transmits into the entering face of corresponding upper prism, and the angle formed by a normal line of the total reflecting face of the upper prism and a ray of the light beam propagating inside the upper prism and onto the total reflecting face is equal to or greater than a critical angle of the upper prism material.

8. The light emitting device according to claim 2, wherein after transmitting into upper prism, the light beam is totally reflected by total reflecting face of the upper prism, then transmit through the upper prism plate; a width of the light beam transmitting through the upper prism plate is approximately equal to a width of the light beam when propagating inside the lower prism, and a direction of the angle range of the light beam transmitting through the upper prism plate includes orientation vertical to upper prism plate.

9. The light emitting device according to claim 2, wherein a curvature center of the entering face and the total reflecting face of upper prism are above a border between the upper prism and the upper prism plate, that is an opposite side of the vertex angle θ of the quasi-triangle of the upper prism, which is near the LGP.

10. The light emitting device according to claim 2, wherein a length of the bottom side of the quasi-triangle of the lower prism (i.e. border line between each lower prism and LGP) is approximately equal to a distance of two neighboring openings of an LCD substrate, and a line drawn from a border of each two neighboring lower prism and vertical to the upper prism plate will pass through corresponding openings of a LCD substrate.

11. The light emitting device according to claim 2, wherein the angles, formed by normal of the total reflecting face of the upper prism and rays of the light beams propagating inside the upper prism and onto the total reflecting face, are equal to or greater than a critical angle of the upper prism material, and a width of the light beams transmitting through upper prism plate is approximately equal to a width of the light beams when propagating inside lower prism, and directions of angle range of the light beams transmitting through upper prism plate include orientations vertical to the upper prism plate.

12. The light emitting device according to claim 1, wherein a range of opposite angle ω of lower prism's emitting face is:
0<ω≦0.5θ_{c}, and
wherein θ_{c} is a critical angle of the lower prism's material;
a range of vertex angle θ of upper prism's quasi-triangle, which is approximately equal to LGP, is:
90°−θ_{c}≦θ≦180°−α−ω, and
θ_{c} is critical angle of the material of the lower prism; α is angle formed by the emitting face and the bottom side of lower prism, and ω is opposite angle of lower prism's emitting face.

13. The light emitting device according to claim 12, wherein a length of the bottom side of the quasi-triangle of each lower prism (i.e. a border line between each lower prism and LGP) is approximately equal to a distance of neighboring openings of the LCD substrate; a lines drawn from borders of each two neighboring lower prisms and vertical to the upper prism plate passes through corresponding openings of the LCD substrate; a width of the light beams transmitting through the upper prism plate is approximately equal to a width of the light beams when propagating inside lower prism, and directions of angle range of the light beams transmitting through upper prism plate include orientations vertical to the upper prism plate.

14. The light emitting device according to claim 13, wherein a range r₁ of curvature radius of upper prism's entering face r₁ is:
T<r₁≦∞, and
a range r₂ of the curvature radius of the reflecting face of the upper prism is:
T<r₂≦∞;
where the T is a shortest distance between the LCD reflecting layer and an intersecting point of an entering face of the upper prism and a total reflecting face of the upper prism.

15. The light emitting device according to claim 14, wherein a curvature center of the entering face and the total reflecting face of upper prism is above the border between upper prism and upper prism plate, that is, an opposite side of the vertex angle θ of the quasi-triangular of the upper prism, which is near the LGP.

16. The light emitting device according to each individual claim from claim 1, wherein a film or filling layer having a refractive index approximately equal to that of the upper prism is applied between the upper prism plate and the LCD substrate.

17. The light emitting device according to claim 2, wherein a film or filling layer having a refractive index approximately equal to that of the upper prism is applied between the upper prism plate and the LCD substrate.

18. The light emitting device according to claim 12, wherein a film or filling layer having a refractive index approximately equal to that of the upper prism is applied between the upper prism plate and the LCD substrate.

19. The light emitting device according to claim 14, wherein a film or filling layer having a refractive index approximately equal to that of the upper prism is applied between the upper prism plate and the LCD substrate.

20. The light emitting device according to claim 15, wherein a film or filling layer having a refractive index approximately equal to that of the upper prism is applied between the upper prism plate and the LCD substrate.
